(19) United States
(12) Patent Application Publication
(10) Pub. No.: US 2007/0138957 A1
(43) Pub. Date: Jun. 21, 2007

(54) ELECTRON EMISSION ELEMENT MANUFACTURING METHOD, DISPLAY UNIT MANUFACTURING METHOD, AND DISPLAY UNIT WITH ELECTRON EMISSION ELEMENT CLEANING FUNCTION

(76) Inventors: Hiroshi Tokue, Yokohama-shi (JP); Takashi Sudo, Chigasaki-shi (JP); Hideharu Takahashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/677,376

(22) Filed: Feb. 21, 2007

Related U.S. Application Data
(63) Continuation of application No. PCT/JP04/13761, filed on Sep. 21, 2004.

(30) Foreign Application Priority Data
Jul. 8, 2003 (JP) 2003-272033

(51) Int. Cl. H01J 1/62

(52) U.S. Cl. 313/512

(57) ABSTRACT

The invention relates to a method of manufacturing an electron emission element, having a step of forming a pair of element electrodes on a rear plate, a step of forming a conductive film to connect the element electrodes, and a forming process of forming an electron emitter on a conductive film by applying power to the element electrodes. The method has an impurities elimination process for eliminating impurities adhered to an electron emitter, by giving element electrodes a voltage of polarity opposite to that in ordinary operation in a vacuum atmosphere, through a baking process, after carbon is adhered to an electron emitter by an activation process. The impurities adhered to the electron emitter can be securely eliminated by performing the impurities elimination process, without using an exclusive processor.

### CROSS REFERENCE TO RELATED APPLICATIONS

This is a Continuation Application of PCT Application No. PCT/JP2004/013761, filed Sep. 21, 2004, which was published under PCT Article 21(2) in Japanese.

### BACKGROUND OF THE INVENTION

1. Field of the Invention

The present invention relates to a method of manufacturing a surface-conduction electron emission element, a method of manufacturing a display unit provided with the electron emission element, and a display unit provided with a function of cleaning the electron emission element.

2. Description of the Related Art

There is a known conventional electron emission element, which utilizes a phenomenon that an electron is emitted by flowing an electric current in a conductive thin film formed on an insulating substrate.

An electron emission element of this type is formed by forming a pair of electrode patterns opposed through a certain gap on an insulating substrate, providing a conductive thin film to connect the pair of electrode patterns through the gap, and providing a crack in the conductive thin film at a substantially midpoint position of the gap by giving a potential difference between the pair of electrode patterns.

When such an electron emission element is operated, an electron is emitted from the crack provided in the conductive thin film, or an electron emitter, by giving a potential difference between the pair of electrode patterns.

Such a display unit is arranged in two or more number on a substrate, and combined with a fluorescent screen, whereby a display unit is formed.

When such a display unit is operated, an external driving signal is given based on image data, a potential difference is selectively given to pairs of electron emission elements, and an electron is emitted. Pixels of a fluorescent screen provided 1:1 to the electron emission elements are selectively excited, and emit light, thereby displaying an image.

For displaying a high-quality image in a display unit provided with the above electron emission elements, each electron emission element does not have uneven characteristics, has stable life and characteristics, and is capable of emitting sufficient electron for displaying.

Adhesion of impurities to an electron emission element during manufacturing is considered a cause of uneven characteristics of electron emission elements. Namely, the impurities adhered to an electron emission element are diffused, absorbed or separated when a display unit is operated for a long time, and the impurities are adhered to or separated from an electron emitter, making the operation of an electron emitter unstable.

Such impurities are generated by an activation process to improve the electron emission performance of an electron emission element, in the step of manufacturing the above-mentioned electron emission element. In the activation process, the electron emission elements forming an electron emitter are arranged in an atmosphere including an organic substance gas, a potential difference is given to a pair of electrodes, and carbon or carbon compounds is deposited. Namely, an intermediate product remained at the end of the activation process and grown to be a final product (carbon or its compounds) becomes impurities causing uneven characteristics of electron emission elements.

Jpn Pat. Appln. KOKAI Publication No. 2000-315458 disclosed a method of eliminating impurities. In this method, a rear plate having electron emission elements is provided in a processing vessel, an electron is emitted from an electron source provided in the processing vessel to a rear plate in a vacuum atmosphere, and a surface absorption gas is emitted.

### BRIEF SUMMARY OF THE INVENTION

In the above conventional method of eliminating impurities, it is necessary to provide a rear plate in a processing vessel having an electron source, and emit an electron to the plate surface in the vessel in a vacuum atmosphere. The unit size becomes large, the work becomes complex, and the display unit manufacturing cost is increased.

Moreover, when the above method of eliminating impurities is adopted, after eliminating the impurities from the surface of a rear plate, a rear plate and a face plate (impurities are eliminated) are placed in another processing vessel, and a display unit is made by combining two plates and sealing their peripheral edges in a vacuum atmosphere. Thus, there is a possibility that impurities are adhered again to the plate surface when moving the plate to another processing vessel. When a display unit manufactured by this method is operated for a long time, residual impurities will be diffused, absorbed or separated, and the impurities are adhered to or separated from an electron emitter, making the operation of an electron emitter unstable with time.

It is an object of the invention to provide a method of manufacturing an electron emission element capable of securely eliminating impurities causing deterioration of characteristics, a method of manufacturing a display unit having the electron emission element, and a display unit having a function of cleaning the electron emission element.

To achieve the above object, a method of manufacturing an electron emission element of the invention has a step of forming a pair of electrodes spaced on a substrate; a step of forming a conductive film to connect the pair of electrodes; a step of forming an electron emitter on the conductive film; and a step of eliminating impurities from the electron emitter, by making the electron emitter emit an electron by applying a voltage to the pair of electrodes, and by making the electron emitter emit an electron by applying a reverse polarity voltage to the pair of electrodes. The method of manufacturing an electron emission element of the invention has a step of forming a pair of electrodes spaced on a substrate; a step of forming a conductive film to connect the pair of electrodes;

a step of forming an electron emitter on the conductive film; a step of pre-driving to make the electron emitter emit an electron by applying a voltage to the pair of electrodes; and a step of eliminating impurities from the electron emitter, by making the electron emitter emit an electron by applying a voltage of polarity opposite to that in the step of pre-driving.

A method of manufacturing a display unit of the invention has a step of forming pairs of electrodes on a substrate; a step of forming conductive films to connect the pairs of electrodes; a step of forming an electron emitter on each of the conductive films; a step of activation to carbonize at least the electron emitters; a step of baking for heating the rear substrate in a vacuum atmosphere; a step of eliminating impurities from the electron emitters, by making the electron emitters emit an electron by applying a voltage to the pairs of electrodes, and by making the electron emitters emit an electron by applying a reverse polarity voltage to the pairs of electrodes; and a step of sealing for combining a front substrate having a fluorescent layer and the rear substrate in a vacuum atmosphere, and sealing peripheral edges of the substrates.

A display unit of the invention has a rear substrate and a front substrate which are opposed to each other through a predetermined clearance; electron emission elements which are provided on the opposite side of the rear substrate, and selectively emit an electron by giving pairs of electrodes a voltage corresponding to an image signal; and an image display which is provided on the opposite side of the front substrate, and displays an image by collision of electrons; the display unit having a cleaning function for cleaning impurities close to the electron emitters, by making the electron emission elements emit an electron by giving the pairs of electrodes a voltage of the same polarity as when displaying an image, and by making the electron emission elements emit an electron by giving the pairs of electrodes a reverse polarity voltage.

According to the invention, it is possible to securely eliminate impurities adhered to an electron emitter by giving electrodes of an electron emission element a voltage of polarity opposite to that in ordinary operation, without requiring an exclusive processing unit. The timing of eliminating impurities may be any timing, even after sealing a rear substrate and a front substrate of a display unit. Therefore, impurities can be securely eliminated during manufacturing an electron emission element, and after manufacturing a display unit. Deterioration of characteristics of an electron emission element can be prevented over a long time, and a display unit having stable operation characteristics capable of displaying a high-quality image can be provided.

### BRIEF DESCRIPTION OF THE SEVERAL VIEWS OF THE DRAWING

FIG. 1 is an external perspective view of a display unit having an electron emission element according to an embodiment of the invention;

FIG. 2 is a sectional view for explaining an internal structure of the display unit of FIG. 1;

FIG. 3 is a partially enlarged sectional view of FIG. 2;

FIG. 4 is a conceptual illustration of an electron emitter with a number of electron emission elements arranged on a rear substrate of the display unit of FIG. 1;

FIG. 5 is a diagrammatic plan view showing an electron emission element according to an embodiment of the invention;

FIG. 6 is a flowchart for explaining a method of manufacturing the electron emission element of FIG. 5;

FIG. 7 is a table showing processing conditions when eliminating impurities from three electron emission elements; and

FIG. 8 is a graph showing changes in an emission current when driving an electron emission element manufactured under the processing conditions of FIG. 7 for a long time.

### DETAILED DESCRIPTION OF THE INVENTION

Embodiments of the invention will be explained in detail hereinafter with reference to the accompanying drawings.

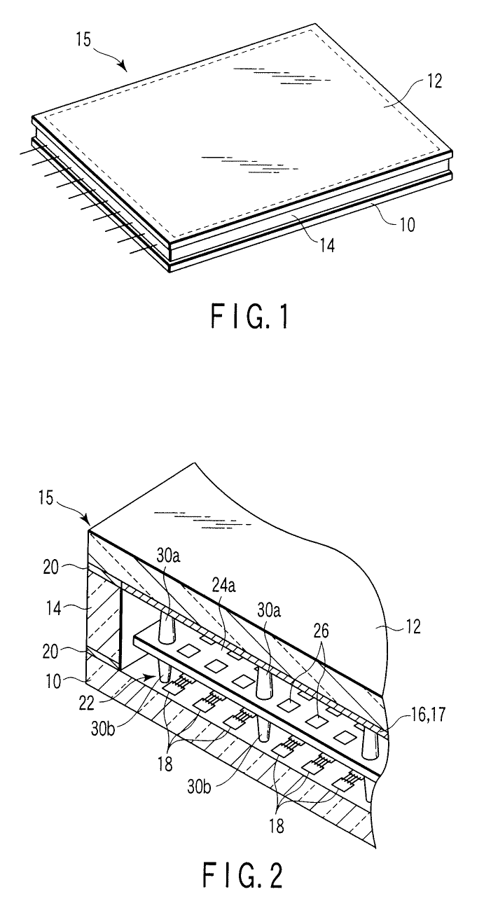

FIG. 1 shows an external perspective view of SED (Surface-conduction Electron-emitter Display) having a number of surface-conduction electron emission elements, as a display unit according to an embodiment of the invention.

The SED has a rectangular rear plate 10 (a substrate, a rear substrate) and a face plate 12 (a front substrate), which are made of quartz. These plates 10 and 12 are opposed at an interval of 1.5-3.0 mm. The rear plate 10 and face plate 12 are joined in the peripheral edge portions through a rectangular frame-like sidewall 14 made of glass, forming a flat rectangular vacuum enclosure 15.

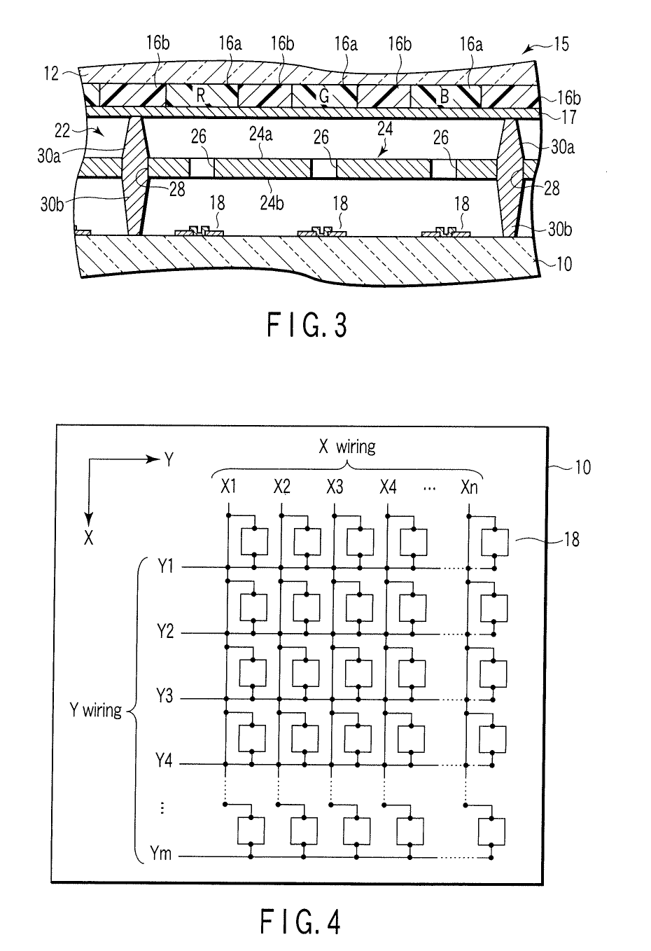

As shown in FIG. 2 and FIG. 3, a fluorescent screen 16 is formed on the inner surface (opposite side) of the face plate 12. The fluorescent screen 16 is configured by red, blue and green fluorescent layers 16a and black colored layers 16b placed between the fluorescent layers. These fluorescent layers 16a are formed like a stripe or a dot. A metal back 17 made of aluminum, for example, is formed on the fluorescent screen 16. A transparent conductive layer or a color filter film made of ITO may be provided between the face plate 12 and fluorescent screen 16. A structure with several layers stacked on the face plate 12 as described above serves as an image display unit of the invention.

On the inner surface (opposite side) of the rear plate 10, there is provided a number of surface-conduction electron emission elements 18 to emit an electron beam for exciting and lighting the fluorescent layer 16a. These electron emission elements 18 are provided 1:1 to each pixel, that is, each fluorescent layer 16a, and arranged in columns and rows. Each of the electron emission elements 18 will be described in detail later.

As shown in FIG. 4, a number of wires to connect the electron emission elements 18 are provided like a matrix on the rear plate 10. A structure with a number of electron emission elements 18 wired and arranged as a matrix on the rear plate 10 serves as an electron emitter of the invention. Various patterns may be used for arranging the electron emission elements 18. Here, one example will be explained with reference to FIG. 4.

An electron emitter is configured by arranging a number of electron emission elements 18 on the inner surface of the rear plate 10. Namely, the electron emission elements 18 are formed in m number in the X (vertical) direction in the drawing, and n number in the Y (horizontal) direction.

One of the electrodes of each electron emission element 18 is connected with a wire common to the electron emission elements 18 arranged on the same line. This is called a Y wiring. The Y wiring consists of m number of wires from Y1 to Ym. The other one of the electrodes of each electron emission element 18 is connected with a wire common to the electron emission elements 18 arranged on the same line. This is called an X wiring. The X wiring consists of n number of wires from X1 to Xn.

The X and Y wirings are formed by the same method of film forming and patterning, by using the same material as a pair of electrode films of each electron emission element 18 to be described later. There is an intersection between the X and Y wirings. The intersection is assumed to be electrically insulated by a not-shown insulating film. As an insulating film, there is SiO₂ formed by vacuum evaporation, printing or spattering, for example.

The Y wiring is to be supplied with a signal voltage (a scan signal) for selecting a line of the electron emission elements 18 arranged in the Y direction, and the X wiring is to be supplied with a signal voltage (a modulation signal) for modulating the current of the electron emission elements 18 arranged in the X direction. Therefore, a driving voltage applied to each electron emission element 18 is supplied as a difference voltage between the scan signal and modulation signal applied to each electron emission element 18.

For example, if a negative threshold voltage Vf [V] is applied to the Y wiring and 0[V] is applied to the X wiring in a specific one of the electron emission elements 18, a threshold voltage Vf will be applied between the electrodes of the element.

Therefore, by applying a negative threshold voltage Vf [V] (inputting a scan signal) to the wiring Y1 and an optional voltage over 0[V] (a modulation signal) to the wiring X2-Xn, for example, an element current is not emitted in the electron emission element 18 connected to the wirings Y1 and X1 (the upper-left element in the drawing), and an optional element current is emitted in the other electron emission elements 18.

As described above, in the electron emitter of the above configuration, a specific electron emission element 18 can be independently selected and driven by using a simple matrix wiring.

The sidewall 14 joining the peripheral edge portions of the face plate 12 and rear plate 10 configured as described above is sealed to the peripheral edge portions of the rear plate 10 and face plate 12, by using a sealing material 20, such as low-melting glass or metals, for joining the face plate 12 and rear plate 10.

The SED also has a spacer assembly 22 provided between the rear plate 10 and face plate 12. The spacer assembly 22 consists of a plate-like grid 24 and a plurality of column-like spacer 30 set up integrally on both sides of the grid.

More specifically, the grid 24 has a first side 24a opposed to the inner surface of the face plate 12, and a second side 24b opposed to the inner surface of the rear plate 10, and is arranged parallel to these plates 10 and 12. The grid 24 has a number of beam-passing holes 26 and a plurality of spacer hole 28, which are formed by etching, for example. The beam-passing holes 26 are arranged opposite to the electron emission elements 18, and the spacer holes 28 are arranged between the beam-passing holes with a predetermined pitch.

The grid 24 is made of am iron-nickel based metal plate in thickness of 0.1-0.25 [mm]. The surface of the grid is formed with a film oxide made of Fe₃O₄ of NiFe₃O₄, for example. The beam-passing hole 26 is formed like a rectangle of 0.15-0.25 [mm]×0.20-0.40 [mm]. The spacer hole 28 is formed like a circle with a diameter of 0.1-0.2 [mm].

On the first side 24a of the grid 24, a first spacer 30a is set up integrally over each spacer hole 28, and its extended end contacts the inner surface of the face plate 12 through the metal back 17 and the black colored layer 16b of the fluorescent screen 16. On the second side 24b of the grid 24, a second spacer 30b is set up integrally over each spacer hole 28, and its extended end contacts the inner surface of the rear plate 10. The spacer hole 28 and the first and second spacers 30a and 30b are aligned, and the first and second spacers 30a and 30b are connected as one body through the spacer hole 28.

Each of the first and second spacers 30a and 30b is formed like a taper with diameter gradually decreased from the grid 24 toward the extended end, more specifically, like a truncated cone.

For example, the first spacer 30a is formed, so that the diameter at the end portion close to the grid 24 is approximately 400 [μm], the diameter of the end portion close to the extended end is approximately 280 [μm], and the height is 0.3-0.5 [mm]. The aspect ratio (height/diameter of the end close to the grid) is 0.75-1.25.

The second spacer 30b is formed, so that the diameter at the end portion close to the grid 24 is approximately 400 [μm], the diameter of the end portion close to the extended end is approximately 150 [μm], and the height is 1-1.2 [mm]. The aspect ratio is 2.5-3.

As described before, the diameter of the spacer hole 28 formed in the grid 24 is 0.1-0.2 [mm], and set to be enough smaller than the diameter of the end portion of the first spacer 30a close to the grid and the diameter of the second spacer 30b close to the grid. As the first spacer 30a and second spacer 30b are aligned integrally and coaxially with the spacer hole 28, the first and second spacers are connected integrally with each other through the spacer hole 28, and configured integrally with the grid 24.

The grid 24 of the spacer assembly 22 configured as above is supplied with a predetermined voltage from a not-shown power supply, preventing a crosstalk, and converges an electron beam emitted from the corresponding electron emission element 18 on a desired fluorescent layer through the beam-passing hole 26. The first and second spacers 30a and 30b contact the inner surfaces of the face plate 12 and rear plate 10, supports an atmospheric load acting on the plates 10 and 12 from the outside of the vacuum enclosure 15, and keeps an interval between the plates at a predetermined value.

When manufacturing a SED by incorporating the spacer assembly 22 produced as above, prepare the rear plate 10 provided with the electron emission elements 18 and joined with the sidewall 14, and the face plate 12 provided with the fluorescent screen 16 and metal back 17. Place the rear plate 10 and face plate 12 in a not-shown vacuum chamber, in the state that the spacer assembly 22 produced as above is positioned on the rear plate 10. Vacuum exhaust the vacuum chamber, and join the face plate 12 with the rear plate 10 through the sidewall 14. A SED having the spacer assembly 22 is manufactured in this way.

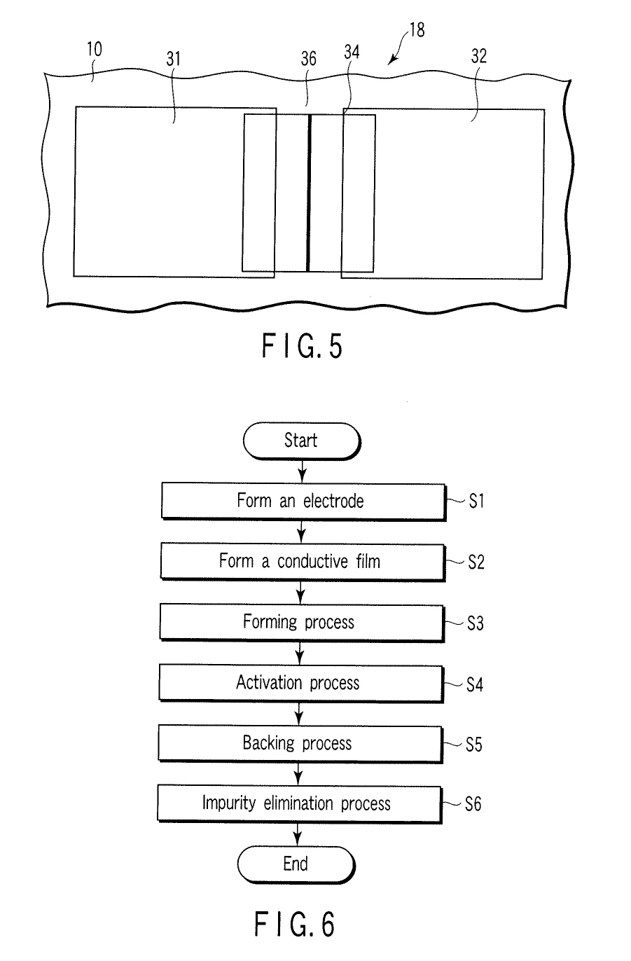

Next, the electron emission element 18 will be explained in details with reference to FIG. 5. FIG. 5 is a schematic plan of one electron emission element 18 viewed from the inner surface of the rear plate 10.

The electron emission element 18 is formed on the inner surface of the rear plate 10, consisting of two (a pair of) element electrodes 31 and 32 separated from each other, a conductive film 34 connecting the gap between the element electrodes 31 and 32, and an electron emitter 36 shaped as a line just like dividing the conductive film 34.

As a material of the rear plate 10, glass with decreased impurities, such as Na, a blue plate glass, a laminate with SiO₂ laminated on a blue glass by spattering, ceramics such as alumina, and a Si substrate may be used, as well as a quarts glass adopted in this embodiment.

As a material of the element electrodes 31 and 32, common conductive materials can be used, and may be selected from metals such as Ni, Cr, Au, Mo, W, Pt, Ti, Al, Cu and Pd, or alloy print conductors, and semiconductors. In this embodiment, the element electrodes 31 and 32 are made of Pt.

Each of the element electrodes 31 and 32 is formed square with one side of 55 μm. The element electrodes are oppositely arranged at the position where the opposite ends and sides form a uniform gap of 20 μm.

As a material of the conductive film 34, there are metals such as Pd, Pt, Ru Ag, Au, Ti, In, Cu, Cr, Fe, Zn, Sn, Ta, W and Pb, oxide conductors such as PdO, SnO₂, In₂O₃, PbO and Sb₂O₃, silicides such as HfB₂, ZrB₂, LaB₆, CeB₆, YB₄ and GdB₄, carbides such as TiC, ZrC, HfC, TaC, SiC and WC, nitrides such as TiN, ZrN and HfN, semiconductors such as Si and Ge, and carbon. In this embodiment, Pd is formed by spattering and heated by oxidation in the air, and then the conductive film 34 with the width of 50 [μm] and length of 40 [μm] is formed by photolithography or dry etching.

The electron emitter 36 consists of a high-resistance crack formed in a part of the conductive film 34, and depends on the thickness, quality and material of the conductive film 34 and the technique such as electrical forming to be described later.

Fine conductive particle with a diameter of several Å to several tens nm may exist inside the electron emitter 36. This fine conductive particle contains a part or all elements of a material forming the conductive film 34. Carbon or carbon oxide is deposited at least in the electron emitter 36 and on the conductive film 34 close to the electron emitter.

Next, an explanation will be given on a method of manufacturing the electron emission element 18 with the structure described above with reference to a flowchart of FIG. 6.

First, clean the rear plate 10 sufficiently with an organic solvent, and form a Pt film as a material of the element electrodes 31 and 32 by vacuum evaporation. Then, form pairs of square element electrodes 31 and 32 on the rear plate 10 by photolithography (step 1).

Next, apply an organic metal solvent to the rear plate 10 provided with the pairs of element electrodes 31 and 32, and form an organic metal film. As an organic metal solvent, it is possible to use a solvent of organic compound containing the material of the conductive film 34 (Pd in this embodiment) as a main element. Heat and bake the organic metal film, pattern the film by lifting off, etching or laser machining, and form a plurality of conductive film 34 (step 2). As a method of applying an organic metal solvent, vacuum evaporation, spattering, chemical-vapor deposition, dispersed coating, dipping or spinning are available.

Further, make a forming process for forming the electron emitter 36 on each conductive film 34 (step 3). The forming process is performed usually by giving a potential difference to a pair of element electrodes 31 and 32 and applying an electric current to the conductive film 34.

Namely, by placing a voltage between the element electrodes 31 and 32, Joule heat is generated in the conductive film 34, a crack is generated in the conductive film 34, and the electron emitter 36 is formed. A pulse wave voltage is desirable for the forming process. Measure a current caused by application of a voltage of approximately 0.1V, for example, and obtain a resistance value. When the resistance value over 1 MΩ is obtained, finish the forming process.

In this embodiment, the rear plate 10 formed with the element electrodes 31/32 and conductive film 34 is placed in a vacuum unit, and a voltage is placed between the electrode elements 31 and 32 in a vacuum on the order of 10⁻⁴ [Pa]. The voltage waveform is to be a rectangular wave, the pulse width is 0.1 [ms], the pulse interval is 16 [ms], and the peak value is 10[V]. The voltage is applied for 60 seconds. As a result, the element electrodes 31 and 32 are formed parallel to the opposite end side, and the electron emitter 36 is formed at substantially the midpoint position of the conductive film 34.

After the above forming process, the electron emission element 18 is subjected to an activation process (step 4). The activation process is performed by placing a pulse-like voltage between the element electrodes 31 and 32 in an atmosphere containing an organic substance gas, as in the forming process. By the activation process, an element current If and emission current Le are extremely increased.

The atmosphere containing an organic substance gas can be formed by utilizing an organic gas remained in an atmosphere after exhausting the vacuum unit by using an oil diffusion pump or a rotary pump, or by leading an appropriate organic substance gas into a vacuum. As an appropriate organic substance, there are aliphatic hydrocarbons, aromatic hydrocarbons, alcohol, aldehyde, ketone, amine, organic acid, etc.

In this embodiment, methane on the order of 10⁻³ [Pa] is introduced into the vacuum unit provided with the rear plate 10, and activation is performed. The voltage applied to the element electrodes 31 and 32 is a 18[V] rectangular pulse. The pulse width is 1 [ms], and the pulse interval is 10 [ms]. The voltage is applied for 30 minutes.

By this activation, carbon or carbon compound of an organic substance existing in the atmosphere is deposited on the electron emission element 18, and at least the electron emitter 36 is carbonized. This extremely increases the element current If and emission current Ie. The film thickness of the deposit is preferably under 50 [nm], more preferably under 30 [nm].

The electron emission element 18 activated as described above is subject to a heating (baking) process in a vacuum atmosphere (step 5). In other words, the rear plate 10 placed in a vacuum unit is heated, and an organic gas remained in a vacuum unit is exhausted. A vacuum exhaust unit to exhaust a vacuum unit is preferably a unit not using oil, so that oil generated from the unit does not affect the characteristics of the electron emission element 18. A partial pressure of an organic component in a vacuum unit is preferably lower than 10⁻⁶ [Pa], at which the above carbon or carbon compound is almost not deposited, more preferably lower than 10⁻⁸ [Pa]. Further, when exhausting a vacuum unit, heat the whole vacuum unit to facilitate exhaustion of organic substance molecules adhered to the inner wall of a vacuum unit or electron emission element 18.

After the above baking process, perform an impurities eliminating process to more securely eliminate impurities causing degradation of the characteristics of the electron emission element 18 (step 6). In this time, a voltage of the same polarity as ordinary driving (a positive polarity in this embodiment) is given in a vacuum atmosphere to the element electrodes 31 and 32 of each electron emission element 18 on the rear plate 10 placed in the vacuum unit, and the element electrodes are pre-driven at the appropriate times. In the pre-driving, a voltage of the same direction and higher than that as ordinary operation is given to the element electrodes 31 and 32 for a predetermined time to stabilize the characteristics of the element. Then, the element electrodes 31 and 32 are given a voltage of the polarity opposite to that in ordinary operation (a negative polarity in this embodiment) for a predetermined time.

Namely, in the impurities elimination process, the impurities are eliminated from the electron emitter 36 by giving the element electrodes 31 and 32 a voltage of the same polarity as that in ordinary operation for a predetermined time, and then giving a voltage of the polarity opposite to that in ordinary operation for a predetermined time. More concretely, the impurities adhered to the electron emitter surface of the “+” electrode side are eliminated by making the electron emitter 36 emit an electron by giving a positive polarity voltage to the element electrodes 31 and 32, and the impurities adhered to the electron emitter surface of the “−” electrode side are eliminated by making the electron emitter 36 emit an electron by giving a negative polarity voltage to the element electrodes 31 and 32.

In this embodiment, the impurities adhered to the surface of the electron emitter 36 are eliminated by giving positive and negative polarity pulse voltages alternately to the element electrodes 31 and 32 in a vacuum atmosphere of 10⁻⁷ [Pa] or lower. In this time, the electron emitted from each electron emission element 18 is detected through a not-shown detector, the emission current is monitored, application of power to the element electrodes 31 and 32 is continued until the emission current reaches an ideal value, and the largeness, pulse width, frequency and polarity of the pulse voltage given to the element electrodes 31 and 32 are appropriately adjusted.

As a pulse voltage waveform, various waveforms such as square, sinusoidal and triangular waves may be used. As a pulse voltage polarity, positive polarity, negative polarity, and alternate positive-negative polarity may be used. Namely, the largeness, pulse width, frequency, polarity and waveform of the pulse voltage may be appropriately adjusted. Power may be continuously applied, until the impurities adhered to the electron emitter 36 of the electron emission element 18 are completely eliminated.

As described hereinbefore, according to this embodiment, it is possible to securely eliminate the impurities adhered to the electron emitter 36 of the electron emission element 18 by a simple method of applying a voltage of the polarity opposite to that in ordinary operation to the element electrodes 31 and 32 of the electron emission element 18, without using an exclusive processor for eliminating impurities. Therefore, the characteristics of the electron emission element 18 can be stabilized for a long period of time.

### EXAMPLE

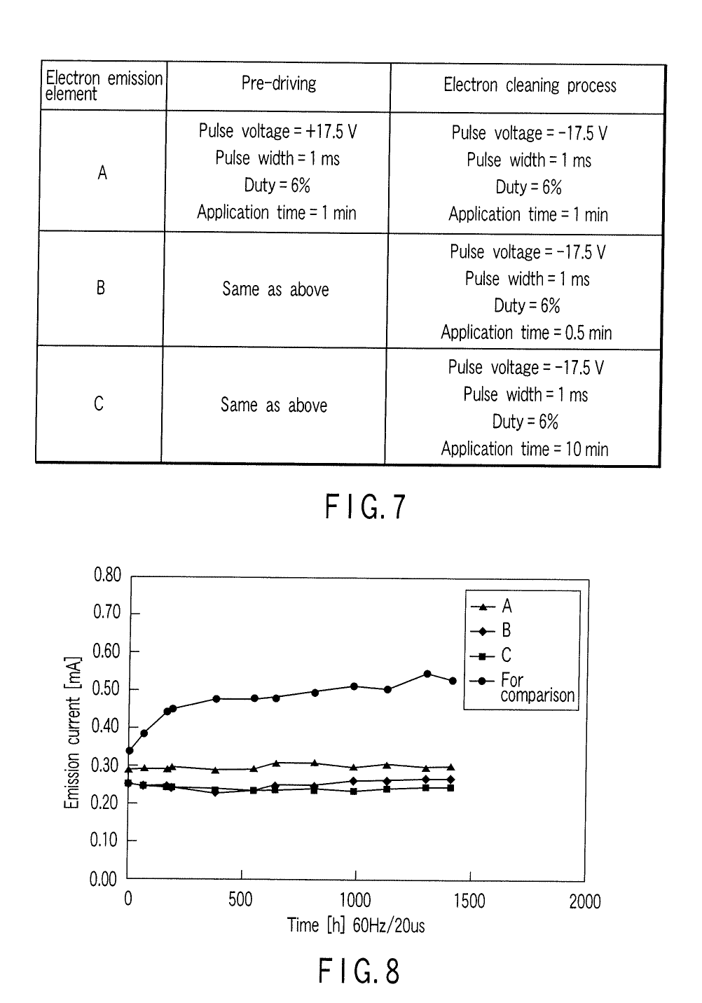

In order to verify the effect of the invention, the inventor performed an impurities elimination process for three electron emission elements A, B and C under different conditions. FIG. 7 shows the processing conditions for the electron emission elements A, B and C. FIG. 8 graphically shows changes in an emission current when the electron emission elements A, B and C are driven for a long time (1400 hours in the embodiment) after the processing. For comparison purposes, FIG. 8 shows changes in an emission current when an electron emission element not subject to the electron cleaning process of FIG. 7 is driven for a long time. A voltage given to the element electrodes 31 and 32 in this time is assumed a square wave pulse.

For the electron emission element A, a pulse voltage is given to the element electrodes 31 and 32 under the conditions that a pulse voltage is +17.5[V], a pulse width is 1 [ms], a pulse rate is 6[%], and an application time is 1 [min], and then the element electrodes are pre-driven. Then, a pulse voltage is given to the element electrodes 31 and 32 under the conditions that a pulse voltage is −17.5[V], a pulse width is 1 [ms], a pulse rate is 6[%], and an application time is 1 [min]. For the electron emission element B, after the pre-driving under the same conditions as for the electron emission element A, a pulse voltage is given to the electron elements 31 and 32 by changing the pulse voltage application time to 0.5 [min]. For the electron emission element C, after the pre-driving under the same conditions as for the electron emission elements A and B, a pulse voltage is given to the electron elements 31 and 32 by changing the pulse voltage application time to 10 [min]. Namely, as the degree of ill effect of gas is different for the electron emission elements A, B and C, only the pulse voltage application time among the processing conditions is changed in the electron cleaning process.

As shown in FIG. 8, the emission current is almost not changed and stable even after a SED having three electron emission elements A, B and C is driven for 1400 hours. Contrarily, the emission current rises with the passage of time in the example not subjected to the electron cleaning process. Namely, in the electron emission element of the example, the adhered impurities affected by gas during the manufacturing process are not completely eliminated, and the emission current is increased by emission of the gas adhered to the surface of the electron emission element by the heat generated by driving.

The invention is not to be limited to the embodiment described above. The invention may be embodied by modifying the components without departing from its essential characteristics. The invention may be embodied in other specific forms by appropriately combining the constituent elements disclosed in the aforementioned embodiment. For example, some of the components shown with the embodiment may be deleted.

For example, in the aforementioned embodiment, the impurities elimination process is performed after the baking process and before the sealing process. But, the impurities may be eliminated during or before the baking process, or after the activation process.

In the aforementioned embodiment, the impurities elimination process is performed during the SED manufacturing process. But, the impurities elimination process may be performed after the SED is manufactured, by opposing the rear plate 10 and face plate 12 and sealing their peripheral edges. In this case, while driving the SED, monitor the emission current emitted from the electron emission element 18 through a not-shown detector, and eliminate the impurities by using the cleaning function when the emission current value (the amount of emitted electron) changes over a preset value. Namely, according to the invention, the impurities elimination process can be performed at a desired timing during or after manufacturing SED. Therefore, changes with time of the emission current value of the electron emission element 18 of SED can be eliminated, and stable driving characteristics can be obtained for a long period of time.

As explained hereinbefore, according to the invention, impurities causing degradation of characteristics of an electron emission element can be securely eliminated by a simple method. An electron emission element can be cleaned at a desired timing after manufacturing a display unit, and degradation of characteristics with time caused by adhesion of impurities can be prevented.

What is claimed is:

1. A method of manufacturing an electron emission element, comprising:
a step of forming a pair of electrodes spaced on a substrate;
a step of forming a conductive film to connect the pair of electrodes;
a step of forming an electron emitter on the conductive film; and
a step of eliminating impurities from the electron emitter, by making the electron emitter emit an electron by applying a voltage to the pair of electrodes, and by making the electron emitter emit an electron by applying a reverse polarity voltage to the pair of electrodes.

2. The method of manufacturing an electron emission element according to claim 1, further comprising a step of activation to carbonize the electron emitter after the step of forming an electron emitter and before the step of eliminating impurities.

3. The method of manufacturing an electron emission element according to claim 2, further comprising a step of baking for a heating process in a vacuum atmosphere after the step of activation and before the step of eliminating impurities.

4. A method of manufacturing an electron emission element, comprising:
a step of forming a pair of electrodes spaced on a substrate;
a step of forming a conductive film to connect the pair of electrodes;
a step of forming an electron emitter on the conductive film;
a step of pre-driving to make the electron emitter emit an electron by applying a voltage to the pair of electrodes; and
a step of eliminating impurities from the electron emitter, by making the electron emitter emit an electron by applying a voltage of polarity opposite to that in the step of pre-driving.

5. The method of manufacturing an electron emission element according to claim 4, further comprising a step of activation to carbonize the electron emitter after the step of forming an electron emitter and before the step of pre-driving.

6. The method of manufacturing an electron emission element according to claim 5, further comprising a step of baking for a heating process in a vacuum atmosphere after the step of activation and before the step of pre-driving.

7. The method of manufacturing an electron emission element according to claim 1 or 4, wherein a voltage applied to the pair of electrodes is a pulse voltage of any one of square, sinusoidal and triangular waves.

8. The method of manufacturing an electron emission element according to claim 7, wherein the pulse voltage includes at least one of positive polarity voltage pulse and negative polarity voltage pulse.

9. The method of manufacturing an electron emission element according to claim 7, wherein the step of eliminating impurities has:
a step of detecting an electron emitted from the electron emitter; and
a step of adjusting at least one of largeness, pulse width, frequency and polarity of a voltage applied to the pair of electrodes, based on the result of detection in the step of detection.

10. A method of manufacturing a display unit, comprising:
a step of forming pairs of electrodes on a substrate;
a step of forming conductive films to connect the pairs of electrodes;
a step of forming an electron emitter on each of the conductive films;
a step of activation to carbonize at least the electron emitters;
a step of baking for heating the rear substrate in a vacuum atmosphere;
a step of eliminating impurities from the electron emitters, by making the electron emitters emit an electron by applying a voltage to the pairs of electrodes, and by making the electron emitters emit an electron by applying a reverse polarity voltage to the pairs of electrodes; and
a step of sealing for combining a front substrate having a fluorescent layer and the rear substrate in a vacuum atmosphere, and sealing peripheral edges of the substrates.

11. The method of manufacturing a display unit according to claim 10, wherein the step of eliminating impurities is performed during or before the step of baking.

12. The method of manufacturing a display unit according to claim 11, wherein the step of eliminating impurities is performed after the step of activation.

13. The method of manufacturing a display unit according to claim 10, wherein the step of eliminating impurities is performed after the step of sealing.

14. The method of manufacturing a display unit according to any one of claims 10-13, wherein a voltage applied to the pairs of electrodes is a pulse voltage of any one of square, sinusoidal and triangular waves.

15. The method of manufacturing a display unit according to claim 14, wherein the pulse voltage includes at least one of positive polarity voltage pulse and negative polarity voltage pulse.

16. The method of manufacturing a display unit according to claim 14, wherein the step of eliminating impurities has:
a step of detecting en electron emitted from the electron emitters; and
a step of adjusting at least one of largeness, pulse width, frequency and polarity of a voltage applied to the pairs of electrodes, based on the result of detection in the step of detection.

17. A display unit comprising:
a rear substrate and a front substrate which are opposed to each other through a predetermined clearance;
electron emission elements which are provided on the opposite side of the rear substrate, and selectively emit an electron by giving pairs of electrodes a voltage corresponding to an image signal; and
an image display which is provided on the opposite side of the front substrate, and displays an image by collision of electrons;
the display unit having a cleaning function for cleaning impurities close to the electron emitters, by making the electron emission elements emit an electron by giving the pairs of electrodes a voltage of the same polarity as when displaying an image, and by making the electron emission elements emit an electron by giving the pairs of electrodes a reverse polarity voltage.

18. The display unit according to claim 17, further comprising:
a detector for monitoring an electron emitted from the electron emitters while displaying an image,
wherein when the amount of electron monitored by the detector changes over a predetermined value, the cleaning function for eliminating impurities by giving positive and reverse polarity voltages alternately to the pairs of electrodes is operated.
